(19) United States
(12) Patent Application Publication
(10) Pub. No.: US 2013/0191883 A1
(43) Pub. Date: Jul. 25, 2013

(54) DEVICE NETWORK SHARING METHOD AND DEVICE CONTROLLING METHOD THEREOF

(71) Applicant: Tien-Chun Tung, Taipei City (TW)

(72) Inventor: Tien-Chun Tung, Taipei City (TW)

(21) Appl. No.: 13/731,021

(22) Filed: Dec. 30, 2012

(30) Foreign Application Priority Data
Jan. 20, 2012 (CN) 201210019558.5

(51) Int. Cl. H04L 29/06

(52) U.S. Cl. CPC H04L 63/10
USPC 726/4

(57) ABSTRACT

A device network sharing method and a device controlling method for sharing and controlling a device with a hardware identifier in a network structure system by connecting the device to the network structure system, letting the device log in a server by the hardware identifier of the device, and completing a verification of the device and announcing connection information of the device in the network structure system. Therefore, a client can complete networking settings of the device without complex networking setting steps. A user can use a controller to log in the server by the hardware identifier of the device, and then acquire connection information of the device, for setting or sharing the device. Thus, a client can search a device desired to be controlled in the network structure system without inputting the URL network address which cannot represent device properties.

### RELATED APPLICATIONS

This application claims the priority of China Patent Application No. 201210019558.5 filed on Jan. 20, 2012, in the State Intellectual Property Office of the P.R.C., the disclosure of which is incorporated herein by reference.

### BACKGROUND OF THE INVENTION

1. Field of the Invention

The invention relates to a device sharing method and a device controlling method, in particular, relates to a device network sharing method and a device controlling method by utilizing a hardware identifier of a device to complete a network connection or a remote sharing of the device.

2. Descriptions of the Related Art

Conventionally, when a user sets or controls a networking device without a user interface, such as a router, a network printer and a webcam, the user usually has to utilize a controller, such as a computer and a smart phone, with a user interface to input an IP address which is pre-set in the networking device. The user has to input much connection information, such as IP address, Account ID (Account Identity) and password, in the controller. Only after long time input, the controller can be connected to the device. If the device is in the local area network behind the router, the user has to set the router for the router to allow the network connection between the device and the controller. To complete the aforementioned setting, the user has to understand concepts with respect to networks. And, for general people as users, the networking setting stated above is pretty complex and difficult.

Modern networks are popular and developed. Every network user usually has many devices capable of networking. It is pretty inconvenient when such complex setting is necessary for each of the devices, and is the problem to be solved by those skilled in this art.

### SUMMARY OF THE INVENTION

In view of the problems of the conventional skills, one purpose of the invention is to provide a device network sharing method and a device controlling method to simplify networking setting steps for a device.

According to another purpose of the invention, a device network sharing method and a device controlling method are provided to search quickly and control a device desired to be controlled in a network structure system.

To achieve the purposes stated above, the invention provides a device network sharing method for a device with a hardware identifier to be shared in a network structure system, including the following steps: providing a server which records a hardware identifier and an APP ID (Application Identity) which have been authorized for an APP (application) of the device; connecting the device to the network structure system, and letting the device log in the server with the hardware identifier and the APP ID of the device; the server verifies the hardware identifier and the APP ID of the device to verify whether the hardware identifier and the APP ID have been authorized or not, if no, then the server interrupts the log-in of the device; if yes, then connection information of the device is announced in the network structure system; providing a controller which can connect to the network structure system and then letting the controller log in the server through entering the hardware identifier of the device desired to be controlled in the controller; the server verifies the APP ID of the controller and the hardware identifier which is entered in the controller to verify if the controller has been authorized to log in the server or not; if no, then the server interrupts the log-in of the controller; if yes, then proceeding to the next step; the controller searches if there is any device announcing connection information with the hardware identifier logged in by the controller in the network structure system, if no, then the controller prompts a client; if yes, then the controller acquires the connection information of the device; and the controller connects the device desired to be controlled through the acquired connection information to set an Account ID and/or an APP Resource of the device, after the setting of the device is completed, the server will record the set Account ID of the device, and then the device utilizes the set Account ID and its own APP ID to log in the server; after the log-in of the device, the Account ID and the connection information of the device are announced in the network structure system to allow others to locate the device in the network structure system.

Additionally, after the device logs in the server, the APP ID and/or the APP Resource of the device can be further announced in the network structure system. The Account ID can be set by the controller, used to apply a new registration in the server and assigned to the device. The Account ID may have a corresponding password for verifying the identity. The APP ID may be registered by the administrator of the server for an APP (application) of the device in advance to define the application procedure or the device type of the device. The APP Resource is related to an APP (application) of the device, and may be set by the controller to define the name or number of the use situation, purpose or feature of the device according to the requirement of an APP (application) of the device. The controller, with the same login Account ID as the device, may connect to the device and acquire an administrator identity, and to set a list of Account IDs which have the right to use and/or control the device, and record the list being set in the device and/or the server.

Moreover, the device may perform a self-test to check if an Account ID has been set or not after power-on; if yes, then the device connects to the network structure system and logs in the server with the set Account ID and its own APP ID registered in the server, and announces connection information in the network structure system; if not, the device connects the network structure system and logs in the server with its own hardware identifier and APP ID registered in the server, and announces connection information in the network structure system. The device network sharing method stated above may further include the following steps: representing the hardware identifier of the device, or the Account ID and/or the APP Resource set for the device by a two-dimensional bar code; the controller scans the two-dimensional bar code of the device to acquire the hardware identifier of the device, or the set Account ID and/or the APP Resource of the device; and the controller connects the network structure system and logs in the server, and using the scanned information to acquire the connection information announced by the device in the network structure system, and then connects the controller to the device.

The steps that the controller sets the device for the device to connect to the network structure system may include: switching the device to Wireless Access Point mode (AP mode), Wi-Fi Direction Connection mode (Wi-Fi Direct mode) or Peer to Peer Connection mode (Ad-Hoc mode), and defining a Wireless SSID (Service Set Identifier) Connection name of the device by using the hardware identifier of the device as a predetermined naming rule; switching the controller to a wireless networking mode, using the controller to input the hardware identifier of the device, to search the Wireless SSID Connection name of the device by the predetermined naming rule; the controller connects to the device through the searched Wireless SSID Connection name, and then to set connection method necessary for connecting to a wide area network for the device; and the device switches to Wi-Fi client mode, to connect to the wide area network and the network structure system with the set connection method and log in the server.

The steps that the controller sets the device to connect to the network structure system may include: switching the device to Wireless Access Point mode, Wi-Fi Direct Connection mode, or Peer to Peer Connection mode, and defining a Wireless SSID Connection name of the device by using the hardware identifier of the device as a predetermined naming rule; searching and listing all of the Wireless SSID Connection names which meet the predetermined naming rule in a wireless network by using the controller; a client uses the controller to confirm the Wireless SSID Connection name of the device according to the hardware identifier of the device, and then connecting to the device by the controller to set connection method necessary for connecting the device to the wide area network; and then switching the device to a Wi-Fi client mode, to connect to the wide area network and the network structure system through the set connection method and log in the server. The device may connect to a wide area network through Ethernet Network Connection method, Wireless Network Connection method, PPPoE (Wideband) Connection method, or Dialup Connection method. The hardware identifier is, for example, a MAC (Media Access Control) address or the hardware number of a chip.

The invention further provides a device controlling method which is adapted to the above device network sharing method, the device controlling method may include the following steps of: the controller connects to the network structure system, and logs in the server with a first Account ID; the controller searches a device with a second Account ID, an APP ID and/or an APP Resource the same as a device desired to be controlled announced in the network structure system; if not found, then the controller prompts a client, if found, then the controller will provide information of all the device(s), which meet the search criteria, to the client, for the client to select a device desired to be controlled therefrom; after the controller performs the selection, the controller may acquire connection information of the selected device desired to be controlled from the network structure system, and connects to the device; and the device verifies if the first Account ID with which the controller logs in the server has been authorized to use the device or not, if not authorized, then the device interrupts the connection of the controller; if authorized, then the controller may control the device according to a control authority that the first Account ID is authorized. If the first Account ID with which the controller logs in the server is the same as the second Account ID owned by the device desired to be controlled, then the controller acquires an administrator identification of the device.

From above, the device network sharing method and the device controlling method have at least the following advantages:

(1) A client does not need to remember complex networking setting steps. A device may announce connection information in a network structure system if a hardware identifier and an APP ID of the device may be used to log in a server and pass a verification of the server. A controller may use the hardware identifier of the device to log in the server and search the device in the network structure system and complete a connection of the device.

(2) A client may use a controller to search a device desired to be controlled in the network structure system according to an Account ID, an APP ID and/or an APP Resource owned by the device in the situation that an input of URL address which cannot represent device features is omitted.

(3) A device uses itself hardware identifier as the predetermined naming rule to define a Wireless SSID Connection name, such that a controller may connect to the device with the naming rule, to set a connection method necessary for the device to connect to a wide area network, so that the device may connect to a network structure system and log in a server, to simplify connection setting of the device.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic diagram of a network structure system utilizing a device network sharing method according to the invention;

FIG. 2 is a flow chart with the steps of a device initialization, log in a server with a hardware identifier, and connection information announcement for a device network sharing method according to the invention;

FIG. 3 is a flow chart with the steps used to set a device networking method wirelessly for a device network sharing method according to the invention;

FIG. 4 is a schematic diagram of the network structure system to set a device networking method wirelessly by utilizing a device network sharing method according to the invention;

FIG. 5 is a flow chart with the steps by which a controller sets an Account ID and an APP Resource of a device for a device network sharing method according to the invention;

FIG. 6 is a flow chart with the steps of a device network controlling method adapted to a device network sharing method according to the invention;

FIG. 7 is a schematic diagram of an embodiment of a network structure system for a device network sharing method according to the invention;

FIG. 8 is a flow chart with steps of utilizing a two-dimensional bar code to acquire a hardware identifier of a device and further acquire connection information of the device for a device network sharing method according to the invention; and

FIG. 9 is a flow chart with steps of utilizing a two-dimensional bar code to acquire an Account ID and/or an APP Resource of a device and further acquire connection information of the device for a device network sharing method according to the invention.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like components.

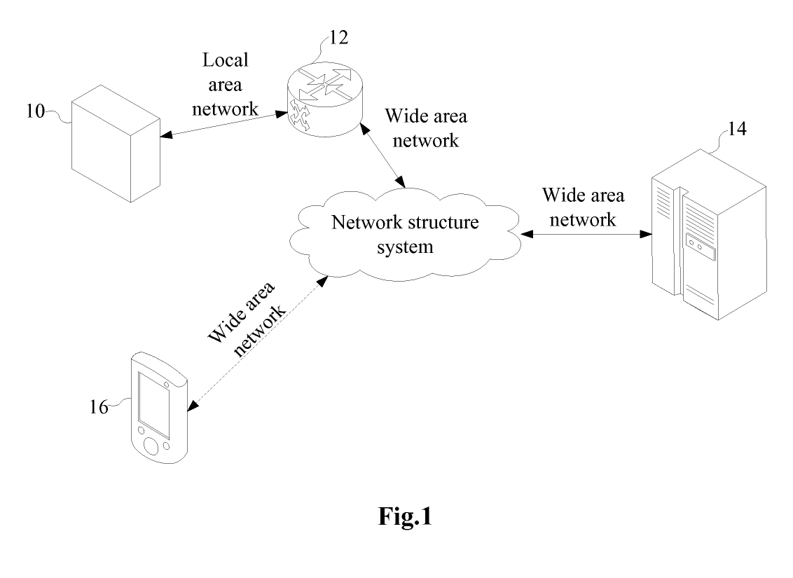

The invention provides a device network sharing method and a device controlling method for sharing a device with a hardware identifier in a network structure system. The device may connect to a network structure system, and log in a server with itself hardware identifier and APP ID (Application Identity). The server may record at least one set of hardware identifier (as an Account ID) and APP ID of authorized device. The server may verify a log-in device with respect to authorization. The APP ID is registered for legally authorized device APP (application) in advance by an administrator of the server to define application procedure or device type of the device. After the device passes the verification of the server, a hardware identifier (as the Account ID), an APP ID and connection information of the device are announced in the network structure system, so that a controller may acquire the connection information of the device with the hardware identifier and the APP ID of the device in the network structure system, and further connect to the device for controlling or setting. Refer to FIG. 1, a device 10 connects to a wide area network and a network structure system through a networking mechanism 12 supported by, for example, Ethernet Network Connection method, Wireless Network Connection method, PPPoE (Wideband) Connection method, or Dialup Connection method, and logs in a server 14 with an APP ID and a hardware identifier (as an Account ID) of the device 10. The hardware identifier is, for example, Media Access Control address, known as MAC code; or the hardware number of a chip, etc. After an APP ID and a hardware identifier of the device 10 pass the verification performed by the server 14, the hardware identifier, APP ID, and connection information of the device 10 will be announced in the network structure system. The connection information is, for example, IP address, connection port, connection encryption method, etc. After that, if a controller 16 logs in the server 14 with the hardware identifier of the device 10 and passes the verification performed by the server 14, the controller 16 may find out and acquire the connection information of the device 10 with the hardware identifier and APP ID of the device 10 in the network structure system and further connects to the device 10 to execute a control procedure for the device 10.

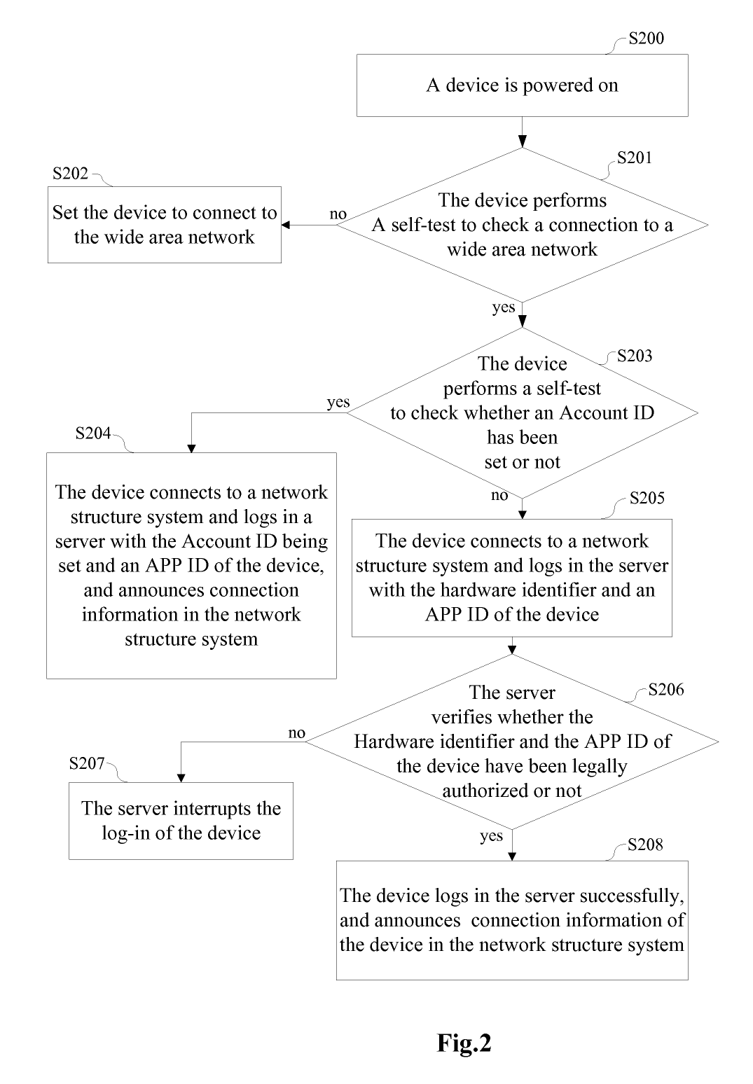

Further refer to FIG. 2, it shows the steps with which a device network sharing method of the invention announces connection information of a device in a network structure system. As shown in FIG. 2, for a device of the invention to log in a network structure system, step S200 shall be performed at first, to connect a device to a power source and perform a power-on procedure. After the device is powered on, proceeding to step S201, the device will perform a self-test to check whether the device is connected to an external network or not, that is, the device checks whether can connect to a wide area network or not. If the device is not connected to an external network, that is, the device cannot connect to the network structure system for sharing, then perform step S202 to set external network connection of the device such that the device may connect to the network structure system. There may be the following methods for the device to connect to the network structure system: Ethernet Network Connection method, Wireless Network Connection method, PPPoE (Wideband) Connection method, or Dialup Connection method. Different connection methods need different settings for the device to connect to the network structure system.

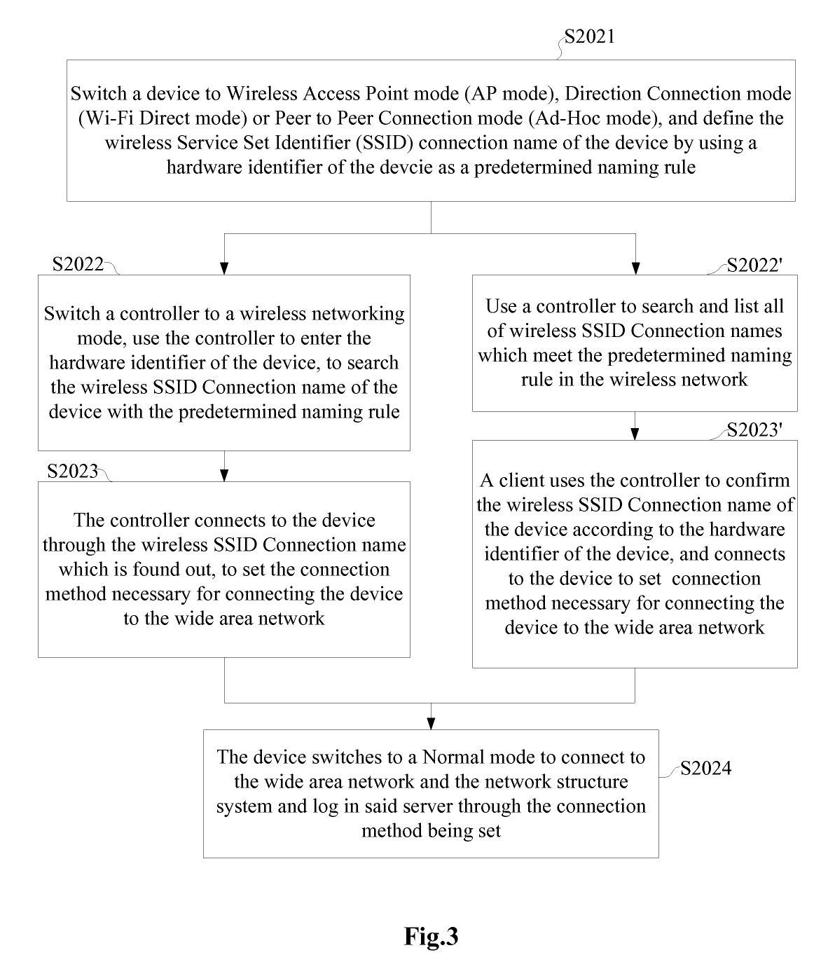

Further refer to FIG. 3 for the setting of the Wireless Network Connection method. FIG. 3 shows the step flow that a device network sharing method of the invention sets networking method of a device with the wireless method. As shown in FIG. 3, when setting the device networking, step S2021 has to be performed at first to switch the device to Wireless Access Point mode (AP mode), Wi-Fi Direction Connection mode (Wi-Fi Direct mode) or Peer to Peer Connection mode (Ad-Hoc mode) by using a functional key or by automation. The Peer to Peer Connection mode is, for example, a Software Enabled Access Point (Soft AP), and defines the wireless Service Set Identifier (SSID) Connection name of the device by using the hardware identifier of the device as a predetermined naming rule. Step S2022 or step S2022′ is proceeded after step S2021 has to be performed. In step S2022, the controller is switched to a wireless networking mode (Wi-Fi mode), and then the controller is used by a client to enter the hardware identifier of the device for searching the wireless SSID Connection name of the device in the wireless network by the predetermined naming rule; if the wireless SSID Connection name of the device is not found out, the controller prompts the client to check the correctness of the entered hardware identifier of the device or to check whether the device is powered on or not; on the contrary, proceeding to step S2023 if the wireless SSID Connection name of the device is found out. In step S2022′, the client utilizes the controller to search and list all of wireless SSID Connection names which meet the predetermined naming rule in the wireless network; if the wireless SSID Connection name which meets the predetermined naming rule is not found out, then the controller prompts the client to check whether the device has not yet been powered on or not; on the contrary, proceeding to step 2023′ if the wireless SSID Connection name which meets the predetermined naming rule is found out.

In step S2023′, the client utilizes the controller to confirm the wireless SSID Connection name of the device according to the hardware identifier of the device, and to connect to the device for setting connection method of the device necessary for the device to connect to a wide area network (for example, setting the connection method supported by networking devices such as Ethernet Network Connection method, Wireless Network Connection method, PPPoE (Wideband) Connection method, or Dialup Connection method). Proceed to step S2024, after networking setting for the device is completed.

In step S2023, the controller connects to the device desired to be controlled through the found out wireless SSID Connection name, to set connection method of the device necessary for the device to connect to the wide area network (for example, setting the connection method supported by networking devices such as Ethernet Network Connection method, Wireless Network Connection method, PPPoE (Wideband) Connection method, or Dialup Connection method). Proceed to step S2024 after networking setting for the device is completed. In step S2024, the device will switch to a Normal mode (for example, a Wi-Fi client mode) automatically to connect to the network structure system and log in the server with the connection method set by the controller.

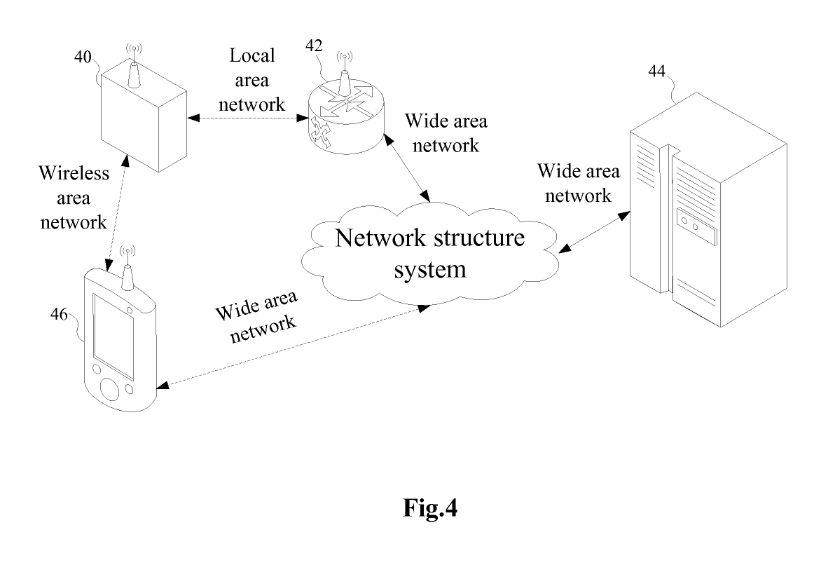

Further, refer to FIG. 4 for a device wireless networking of a network structure system according to a device network sharing method of the invention. A device 40 announces a wireless SSID Connection name defined by using a hardware identifier of the device 40 as a predetermined naming rule. A controller 46 acquires the wireless SSID connection name announced by the device 40 to connect to the device 40, and further may set connection method necessary for the device 40 to connect to a wide area network. After that, the device 40 may connect to the wide area network through a networking means 42 (for example, the networking device supported by a connection method such as Ethernet Network Connection method, Wireless Network Connection method, PPPoE (Wideband) Connection method, or Dialup Connection method), and log in a server 44 with the hardware identifier and an APP ID of the device 40. After the hardware identifier and APP ID of the device 40 pass the verification of the server 44, connection information of device 40 will be announced in the network structure system. Thus, complex setting steps are unnecessary for a client to announce connection information of a device in the network structure system and share the device on the network.

As shown in FIG. 2, in step S201, if a device performs a self-test and finds out the existence of a network connection for a wide area network, then proceed to step S203; in step S203, the device performs a self-test to check whether an Account ID has been set or not; if the self-test result is that an Account ID has been set for the device, then step S204 is proceeded such that the device connects to the network structure system and logs in the server with the Account ID being set and the APP ID of the device, and connection information of the device is announced in the network structure system for the controller or other device to search and sharing the device in the network structure system; if the self-test result is that an Account ID has not been set in step S203, then step S205 is proceeded such that the device connects to the network structure system and logs in the server with the hardware identifier and the APP ID of the device, and then step S206 is proceeded; in step S206, the server verifies whether the APP ID and the hardware identifier of the device have been legally authorized; step S208 is proceeded if the server verifies that the APP ID and the hardware identifier of the device have been legally authorized, such that the device logs in the server successfully and announces connection information of the device in the network structure system; step S207 is proceeded if the server verifies that the APP ID and the hardware identifier of the device have not yet been authorized, such that the server interrupts the log-in of the device to prevent from inappropriate occupation for the resource of the server.

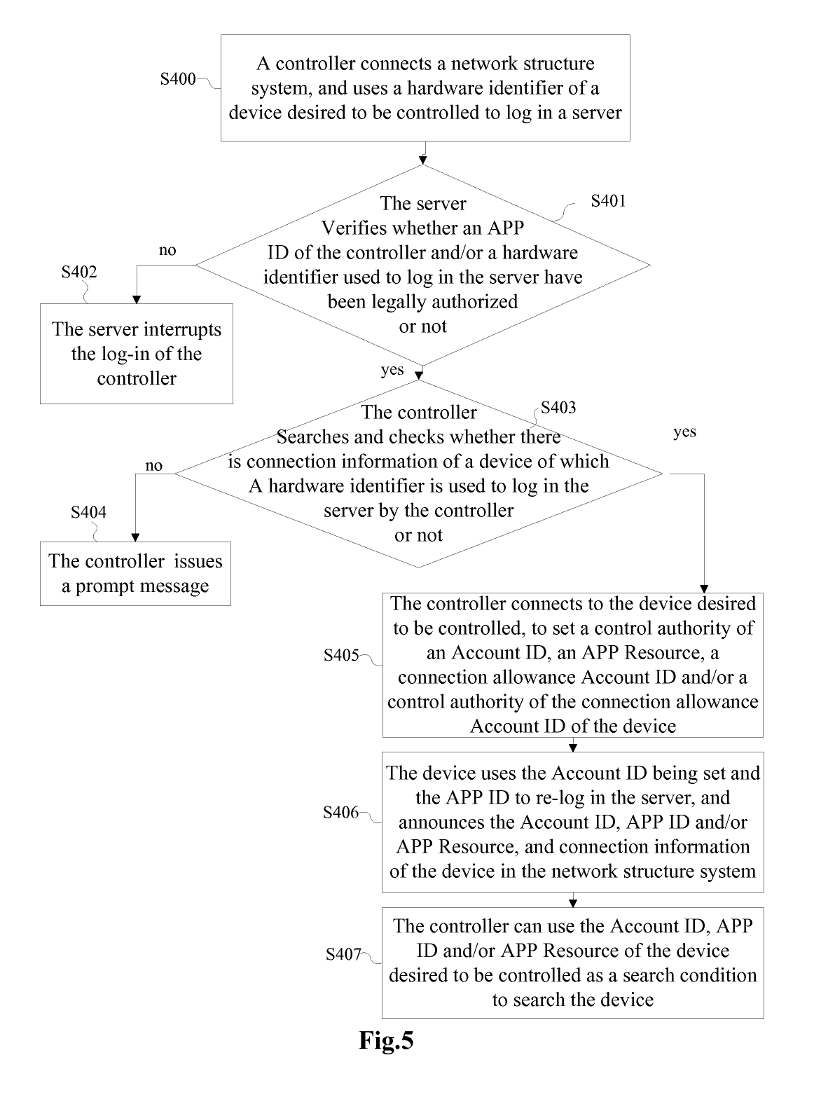

Further, refer to FIG. 5, which shows setting steps for an Account ID and an APP Resource of a device according to a device network sharing method of the invention. As shown in FIG. 5, in step S400, a client utilizes a controller to connect to a network structure system, and logs in a server with an APP ID of the controller and a hardware identifier of a device desired to be controlled, and then step S401 is proceeded. In step S401, the server verifies whether the hardware identifier used by the controller to log in the server and/or the APP ID of the controller has been legally authorized; if no, it represents that the hardware identifier used by the controller to log in the server and/or the APP ID of the controller has not yet been authorized, then step S402 is proceeded; if yes, it represents that the APP ID of the controller and the log-in hardware identifier have passed a verification of the server in step S401, then step S403 is proceeded. In step S402, the server interrupts the log-in of the controller to prevent from inappropriate occupation for the resource of the server. In step S403, the controller may search and check whether there is a device having the APP ID, which announces connection information with the hardware identifier with which the controller logs in the server; if not, it represents that the device desired to be controlled does not connect to the network structure system, and then step S404 is proceeded; if yes, it represents that the device having the APP ID which announces connection information by using the hardware identifier with which the controller logs in the server is found out, then step S405 is proceeded. In step S404, the controller prompts a client to perform connection check steps of the device, the connection check steps include confirming whether the device is powered-on or not and confirming whether a connection setting of the device is completed or not. In step S405, the controller acquires the connection information of the device desired to be controlled from the network structure system to connect to the device desired to be controlled, and sets an Account ID, an APP Resource, a permission use list of account IDs, and/or a control authority of the permission use list of account IDs with an administrator identity. It should be emphasized that the controller may set the permission use list of Account ID on the device with the administrator identity at any time, for example, a connection whitelist (an Account ID list for allowed connection devices) or a connection blacklist (an Account ID list for rejected connection devices). Additionally, the APP Resource is related to an APP (application) of the device. The APP Resource is set by a client to define a name or number which meets a use situation, purpose or feature according to the APP (application) of the device. The Account ID can be assigned by a client with a controller, used to apply a registration in the server and assigned to the device; the Account ID may have a corresponding password for verifying an identity. When logging in the server, the Account ID is used accompanied with the password to enhance the security of Account ID use such that inappropriate use of the device for network sharing is prohibited.

Subsequently, in step S406, the device utilizes the Account ID being set and the APP ID of the device to re-log in the server, and announces the Account ID, the APP ID and/or the APP Resource, and the connection information of the device in the network structure system. Thus, the client does not need to be the same as conventional skills, which can only search devices in a network with an URL (Uniform Resource Locator) address which cannot represent the device. In step S407, after the controller logs in the server, the client may utilize the controller only with the Account ID, APP ID and/or APP Resource of the device desired to be controlled to search the device. Therefore, the device network sharing method of the invention may find out the device desired to be controlled and connect to the device in the network structure system, by using the Account ID, APP ID and/or APP Resource owned by the device such that it is helpful to share the device in the network structure system.

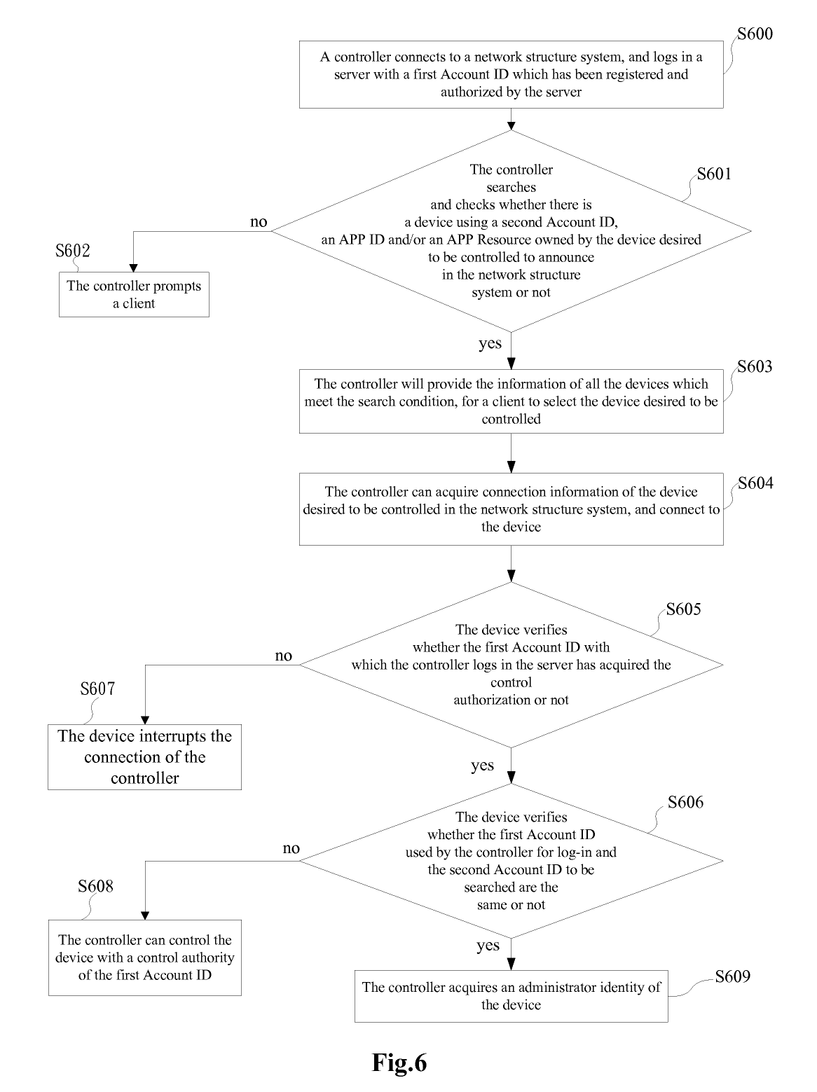

Further, refer to FIG. 6, which shows a step flow chart of a device network controlling method adapted to a device network sharing method of the invention. As shown in FIG. 6, in step S600, a controller connects to a network structure system and logs in a server with a first Account ID which has been registered and authorized by the server, and then step S601 is proceeded. In step S601, the controller searches and checks whether there is a device desired to be controlled which logins with a second Account ID, an APP ID and/or an APP Resource and announces the connection information of the device in the network structure system; if no, it represents that the device desired to be controlled does not connect to the network structure system, step S602 is proceeded; if yes, it represents that the device which meet the search condition is found out, the step S603 is proceeded. In step S602, the controller prompts a client that, for example, the device desired to be controlled is not found out, or suggests to check for the connection of the device. In step S603, the controller will provide a client the information of all the devices which meet the search condition for the client to select the device desired to be controlled, and then step S604 is proceeded. In step S604, the controller may acquire connection information of the device desired to be controlled from the network structure system and connect to the device, and step S605 proceeds after the controller connects to the device. In step S605, the device verifies whether the first Account ID for the controller to log in the server has been authorized or not; if not, it represents that the first Account ID does not allow to control the device, and then step S607 is proceeded; if yes, it represents that the first Account ID has passed the verification of the device and acquires a control authorization, then step S606 proceeds. In step S607, the device interrupts the connection of the controller to prohibit the device from being inappropriately controlled. In step S606, the device verifies whether the first Account ID for the controller to log in the server and the second Account ID of the device desired to be controlled under search are the same or not; if not, then proceeds to step S608; if yes, then proceeds to step S609. In step S608, the controller may control the device according to the control authority of the first Account ID set in the device. In step S609, the controller acquires an administrator identity of the device, and the controller will be authorized by the device to fully control the device.

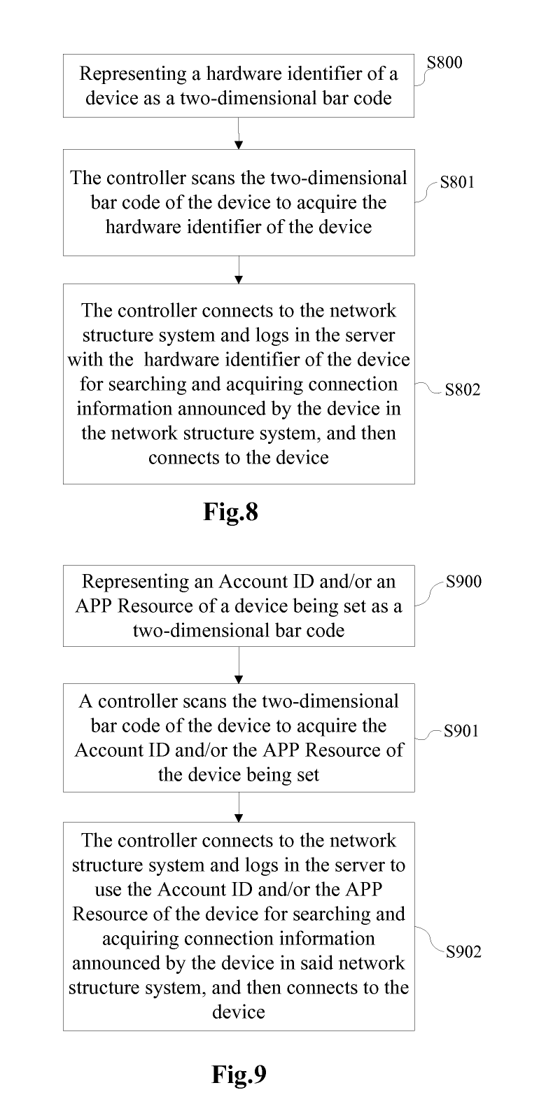

Further, refer to FIG. 8 and FIG. 9. For the purpose of making a client acquire connection information conveniently, a hardware identifier owned by a device or an Account ID and/or an APP Resource being set of the device may be represented as a two-dimensional bar code, and marked on the device or other sites, as shown in step S800 and S900. Next, a controller may scan the two-dimensional bar code of the device to acquire the hardware identifier of the device, or the Account ID and/or the APP Resource information of the device, as shown in step S801 and S901. Then, the controller may connect to a network structure system and log in a server with the acquired device information, and then the controller may search the device to be controlled with the acquired device information and acquire connection information announced by the device in the network structure system under the situation that no input is necessary, to further connect to the device and perform the control or setting of the device, as shown in step S802 and S902. Thus, the controller connects to or searches a device only by scanning the two-dimensional bar code of the device to simplify the procedure of the control or setting for the device.

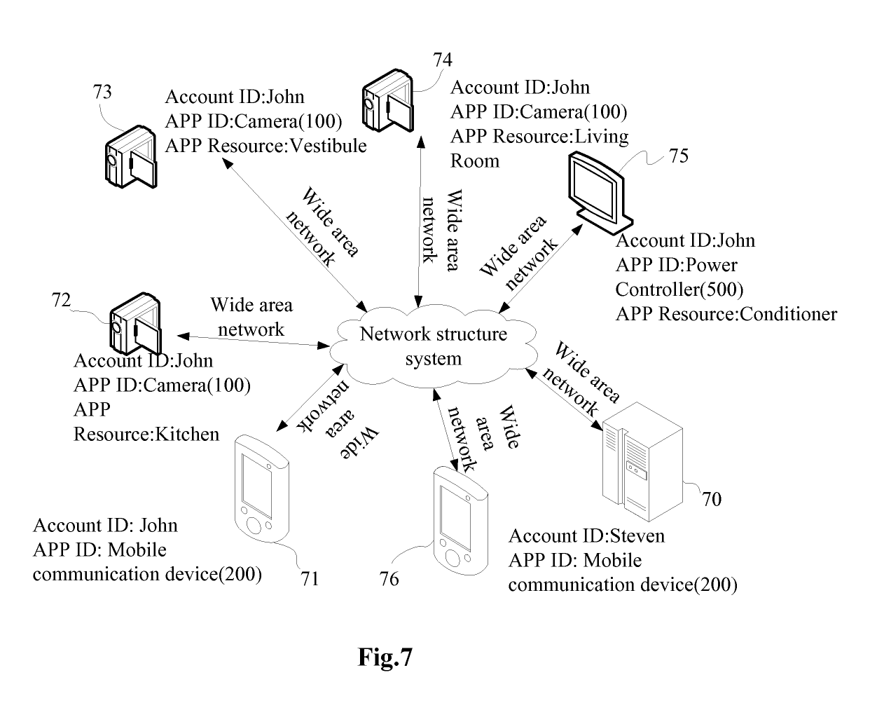

Refer to FIG. 7, which is a schematic diagram of an embodiment of a network structure system for a device network sharing method according to the invention. In FIG. 7, devices 72, 73, 74, 75 have already connected to a network structure system and logged in a server 70, and a setting for an Account ID and/or an APP Resource of devices 72, 73, 74, and 75 has already been completed by a controller 71. Moreover, an administrator of the server 70 has registered and recorded the APP ID of devices 72, 73, 74, and 75 in advance, respectively. The APP ID is used to define an application procedure or a device type of a device. For example, in FIG. 7, a device represented by APP ID 100 is a camera, a device represented by APP ID 500 is a power controller, and a device represented by APP ID 200 is a mobile communication device. The APP Resource relates to an APP (application) of the device. The APP Resource is set by a client to define a use situation, purpose, or feature which meets device according to a requirement the APP of the device. Different definitions are for different client requirements. In this example, for example, the APP ID of devices 72, 73, and 74 are all cameras, while the APP Resource thereof is set as Kitchen, Vestibule and Living Room according to application situations, respectively. The APP ID of device 75 is Power Controller. The APP Resource of device 75 is set as Conditioner according to its purpose to differentiate from other Power Controllers.

As shown in FIG. 7, controllers 71 and 76 are mobile communication devices (for example, mobile phone) capable of connecting to a network structure system. controllers 71 and 76 are registered and recorded as APP ID 200 in the server 70. After a client logs in the server 70 with Account ID John and APP ID 200 by controller 71 (or with Account ID Steven by controller 76), the client may enter an Account ID (for example, John) and/or an APP Resource (for example, Vestibule or Conditioner) of the device desired to be controlled on the controller to search the device desired to be controlled in the network structure system (what should be explained is that the device should log in the server and announce its connection information in the network structure system in advance). After search, if multiple devices which meet the search conditions are found out, controller 71 (or controller 76) will provide all the devices which meet the search conditions to the client. The client may know the device type, purpose and feature of the device from the APP ID and the APP Resource with respect to the device presented by controller 71 (controller 76) to further select the device desired to be controlled and acquire connection information of the selected device. As a result, the client may connect to one or multiple devices in the network structure system directly for control. For example, the client may connect to cameras of devices 72, 73 and 74 to monitor situations around a house. Or, the client may connect only to device 75 to check power consumption status of device 75 which APP Resource is Conditioner, or to turn on or off device 75, remotely.

Additionally, different kinds of devices may also be controlled by different APPs (application), but different kinds of devices may also be controlled by multiple APPs, respectively. For example, an APP may be utilized to find out a camera and an air conditioner, to be controlled as “Account ID/APP ID” of camera and “Account ID/APP ID” of air conditioner in a network structure system. However, it is of low probability that the APP may also control a printer because the control of the printer and that of the camera/air conditioner are completely not the same. It is very difficult to perform the implementation with a single APP. It is also uneasy for clients to understand how to perform the operation of the APP. Therefore, another APP is necessary to control the printer in such a situation.

In summary, the invention provides a device network sharing method and a device controlling method to share a device with hardware identifiers in a network structure system with steps inclusive of: recording an authorized hardware identifier in the server, and registering an APP ID of an authorized device; connecting the authorized device to the network structure system, and letting the device log in the server and performing verification with the hardware identifier and the APP ID of the device by the server, if the device passes the verification, then announcing connection information of the device in the network structure system, such that a controller may find and connect to the device and set an Account ID and/or an APP Resource owned by the device, after that, the device will login and announce the Account ID, the APP ID and/or the APP Resource, and the connection information in the network structure system and the device may be shared in the network. After a client logs in the server with authorized APP ID of the device by the controller, the device may be searched in the network structure system with conditions of an Account ID, an APP ID and/or an APP Resource without using URL addresses, which cannot represent feature of the device, such that the device desired to be controlled may be found out quickly in the network structure system.

Additionally, a device may announce a wireless SSID Connection name defined by a hardware identifier of the device for a controller to find out and connect to the device, and set a connection method necessary for a wide area network connection for the device, such that the device may connect to the wide area network and the network structure system and log in the server with the connection method being set.

While the present invention has been shown and described in connection with the embodiments, it will be apparent to those skilled in the art that modifications and variations can be made without departing from the spirit and scope of the invention as defined by the appended claims.

What is claimed is:

1. A device network sharing method for sharing a device with a hardware identifier in a network structure system, including the steps as following:
providing a server which records a hardware identifier and an APP ID which have been authorized;
connecting said device to said network structure system;
letting said device log in said server with said hardware identifier and said APP ID of said device;
verifying whether said hardware identifier and said APP ID of said device have been authorized by said server or not, if no, then said server interrupts the log-in of said device; if yes, then connection information of said device is announced in said network structure system;
providing a controller which is capable of connecting to said network structure system;
letting said controller log in said server by entering the hardware identifier of the device desired to be controlled in said controller;
verifying whether said APP ID of said controller and said hardware identifier which is entered in said controller have been authorized by said server or not; if no, then interrupting the log-in of said controller by said server; if yes, then proceeding with the next step;
letting said controller search whether there is a device which utilizes said hardware identifier to log in and announce the connection information in said network structure system, if no, then a prompt message is issued by said controller; if yes, then acquiring the connection information of said device by said controller;
letting said controller connect to said device desired to be controlled by the connection information which is acquired, to set an Account ID and/or an APP Resource of said device;
after completing the setting of said device, letting said device log in said server with the Account ID being set and the APP ID of said device, after the log-in of said device, the Account ID and the connection information of said device is announced in said network structure system to allow locating of said device in said network structure system.

2. The device network sharing method of claim 1, wherein further announcing the APP ID and/or the APP Resource of said device in said network structure system after said device logs in said server.

3. The device network sharing method of claim 1, wherein said Account ID can be assigned by a client with a controller, used to apply a registration in said server and assigned to said device, said Account ID further has a password for verifying an identity, said APP ID is pre-registered for said device by an administrator of said server to define an application procedure or a device type of said device, said APP Resource is related to said APP ID, assigned by the client to define a name or a number which meets an use situation, a purpose or a feature of said device according to said APP ID.

4. The device network sharing method of claim 3, wherein said controller can log in with the Account ID owned by said device, and connect to said device and acquire an administrator identity, to set a list of Account IDs which have the right to use and/or control said device, and record the list being set in said device and/or said server.

5. The device network sharing method of claim 1, wherein, said device will perform a test to check whether said Account ID is legal or not, after said device is powered-on; if yes, then said device connects to said network structure system and logs in said server with said Account ID being set and said APP ID of said device registered in said server, and announces said connection information in said network structure system; if no, said device connects said network structure system and logs in said server with said hardware identifier of said device and said APP ID registered in said server, and announces said connection information in said network structure system.

6. The device network sharing method of claim 1, wherein the steps with which said controller sets said device for said device to be connected to said network structure system include:
switching said device to a Wireless Access Point mode (AP mode), a Wi-Fi Direction Connection mode (Wi-Fi Direct mode) or a Peer to Peer Connection mode (Ad-Hoc mode), and defining a Wireless SSID Connection name of said device by using said hardware identifier of said device as a predetermined naming rule;
switching said controller to a wireless networking mode, entering said hardware identifier of said device in said controller for said controller to search said Wireless SSID Connection name of said device according to said predetermined naming rule;
connecting said controller to said device with said Wireless SSID Connection name which is searched out, to set a connection method necessary for said device be connected to a wide area network; and
switching said device to a client mode for connecting said device to said wide area network and said network structure system and letting said device log in said server through said connection method being set.

7. The device network sharing method of claim 1, wherein the steps with which said controller sets said device for said device to be connected to said network structure system include:
switching said device to a Wireless Access Point mode (AP mode), a Wi-Fi Direction Connection mode (Wi-Fi Direct mode) or a Peer to Peer Connection mode (Ad-Hoc mode), and defining a Wireless SSID Connection name of said device by using the hardware identifier of said device as a predetermined naming rule;
searching all of the Wireless SSID Connection names which meet the predetermined naming rule in a wireless network by using said controller;
using said controller to search out said Wireless SSID Connection name which is defined by the hardware identifier of said device;
connecting said controller to said device, to set a connection method necessary for said device to connect to a wide area network; and
switching said device to a client mode for said device connecting to said wide area network and said network structure system and letting said device log in said server through said connection method being set.

8. The device network sharing method of claim 1, wherein, said hardware identifier is a MAC (Media Access Control) address or a hardware number of a chip.

9. The device network sharing method of claim 1, further includes the following steps:
representing the hardware identifier of said device as a two-dimensional bar code;
scanning the two-dimensional bar code of said device to acquire the hardware identifier of said device by said controller; and
connecting said controller to said network structure system and letting said controller log in said server with said acquired hardware identifier of said device;
acquiring the connection information of said device announced in said network structure system with the acquired hardware identifier of said device; and
connecting said controller to said device.

10. The device network sharing method of claim 1, further includes the following steps:
representing the Account ID and/or the APP Resource of said device being set as a two-dimensional bar code;
scanning the two-dimensional bar code of said device to acquire information of the Account ID and/or the APP Resource of said device being set by said controller; and
connecting said controller to said network structure system and letting said controller log in said server;
using the scanned information to acquire the connection information of said device announced in said network structure system with the acquired information of said device; and
connecting said controller to said device.

11. A device controlling method adapted to the device network sharing method of claim 4, wherein, including the steps of:
connecting said controller to said network structure system, and using a first Account ID to let said controller log in said server;
letting said controller search whether there is a device which logins and announces a second Account ID, the APP ID and/or the APP Resource of the device desired to be controlled or not in the network structure system;
if no, then a prompt message is issued by said controller; if yes, then said controller provides device information which meet the searching condition for the client to select the device desired to be controlled;
acquiring the connection information of the selected device desired to be controlled in said network structure system by said controller and connecting said controller to said device; and
verifying whether said first Account ID with which said controller logs in said server has been authorized by said device or not, if no, then said device interrupts the connection of said controller; if yes, then said controller controls said device according to an authorized control authority of said first Account ID.

12. The device network controlling method of claim 1, wherein, if the first Account ID with which said controller logs in said server is the same as the second Account ID owned by the device desired to be controlled, then said controller acquires the administrator identity of said device, and said controller will be authorized by the device to fully control the device.
